(19) United States
(12) Patent Application Publication
(10) Pub. No.: US 2025/0212037 A1
(43) Pub. Date: Jun. 26, 2025

(54) METHOD AND APPARATUS FOR DATA SCHEDULING WITHIN MEASUREMENT GAPS

(71) Applicant: MEDIATEK INC., Hsinchu City (TW)

(72) Inventor: Chi-Hsuan HSIEH, Hsinchu City (TW)

(21) Appl. No.: 18/849,824

(22) PCT Filed: Apr. 11, 2023
(86) PCT No.: PCT/CN2023/087562

§ 371 Date: Sep. 23, 2024

Related U.S. Application Data
(60) Provisional application No. 63/330,335, filed on Apr. 13, 2022.

(51) Int. Cl. H04W 24/10; H04W 52/02; H04W 72/23

(52) U.S. Cl. CPC H04W 24/10; H04W 52/0212; H04W 72/23

(57) ABSTRACT

Various solutions for data scheduling within measurement gaps with respect to user equipment and network apparatus in mobile communications are described. An apparatus may receive a measurement gap configuration associated with at least one measurement gap from a network node. The apparatus or the network node may determine whether at least one condition is met. The apparatus may perform data reception or data transmission within the at least one measurement gap in an event that the at least one condition is met.

### CROSS REFERENCE TO RELATED PATENT APPLICATION(S)

The present disclosure claims the priority benefit of U.S. Provisional Patent Application No. 63/330,335, filed on 13 Apr. 2022. The contents of aforementioned applications are herein incorporated by reference in their entirety.

### TECHNICAL FIELD

The present disclosure is generally related to mobile communications and, more particularly, to data scheduling within measurement gaps with respect to user equipment (UE) and network apparatus in mobile communications.

### BACKGROUND

Unless otherwise indicated herein, approaches described in this section are not prior art to the claims listed below and are not admitted as prior art by inclusion in this section.

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board, has decided to focus the future NGMN activities on defining the end-to-end requirements for 5G new radio (NR) systems and 6G systems.

In conventional communication technology, the UE may be configured a measurement gap for neighbor cell measurement. That is to say, in the measurement gap, the network node may not configure UE to transmit or receive data. However, for some real-time application (e.g., virtual reality (VR) or augmented reality (AR)), the services may be affected/interrupted when the UE needs to perform neighbor cell measurement on the configured measurement gap. The user experience will become bad.

Accordingly, how to maintain the service quality and reduce data interruption of the real-time application is worthy of discussion. Therefore, there is a need to provide proper schemes to allow data scheduling within the measurement gaps.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to data scheduling within measurement gaps with respect to user equipment and network apparatus in mobile communications.

In one aspect, a method may involve an apparatus receiving a measurement gap configuration associated with at least one measurement gap from a network node. The method may also involve the apparatus or the network node determining whether at least one condition is met. The method may further involve the apparatus performing data reception or data transmission within the at least one measurement gap in an event that the at least one condition is met.

In one aspect, an apparatus may comprise a transceiver which, during operation, wirelessly communicates with a network node. The apparatus may also comprise a processor communicatively coupled to the transceiver. The processor, during operation, may perform operations comprising receiving, via the transceiver, a measurement gap configuration associated with at least one measurement gap from a network node. The processor may also perform operations comprising determining whether at least one condition is met. The determination of whether at least one condition is met may also be perform by the network node. The processor may further perform operations comprising performing, via the transceiver, data reception or data transmission within the at least one measurement gap in an event that the at least one condition is met.

In one aspect, a method may involve an apparatus (e.g., a network node) transmitting a measurement gap configuration associated with at least one measurement gap to a user equipment (UE). The method may also involve the apparatus determining whether at least one condition is met. The method may further involve the apparatus determining whether to schedule data within the at least one measurement gap according to the at least one condition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to data scheduling within measurement gaps with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

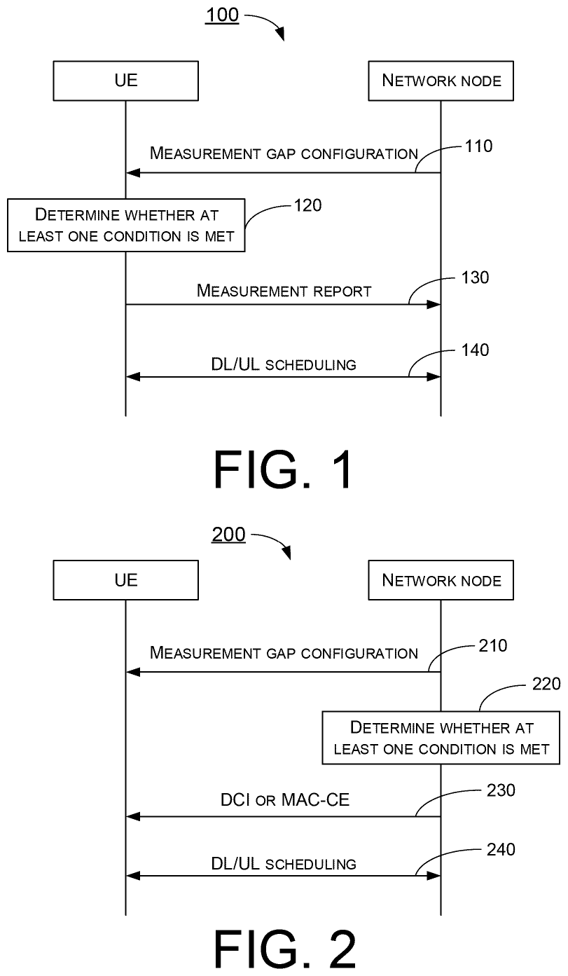

FIG. 1 illustrates an example scenario 100 under schemes in accordance with implementations of the present disclosure. Scenario 100 involves a UE and a network node, which may be a part of a wireless communication network (e.g., an LTE network, a 5G/NR network, an IoT network or a 6G network). As shown in FIG. 1, at 110, the UE may receive a measurement configuration from the network node. The measurement gap configuration may be associated with one or more measurement gaps. For example, the measurement gap may configure one or more measurement gaps.

The measurement gap may be originally configured to the UE for measurement by the network node. The measurement gap may comprise at least one of a measurement gap for band configuration, a measurement gap for positioning, a measurement gap for a radio link monitoring, a measurement gap for a beam failure detection, a measurement gap for a layer 1 (L1)-reference symbol received power (RSRP) measurement and a measurement gap for a candidate beam detection, etc.

Then, at 120, the UE may determine whether at least condition is met. The at least one condition is used to determine whether the downlink scheduling and the uplink scheduling are allowed in at least one measurement gap. When the at least one condition is met, the downlink (DL) scheduling and the uplink (UL) scheduling between UE and network node may be allowed in the at least one measurement gap. In some implementations, the determination of whether at least condition is met may be performed by the network node. The network node may determine whether the DL scheduling and/or UL scheduling are allowed according to the at least condition. The network node may also indicate the UE in an event that the at least condition is met. Then the UE may be allowed to perform data reception or data transmission within the at least one measurement gap.

In an example, the condition may be associated with at least one power saving configuration. The power saving configuration may be originally configured to the UE by the network node for power saving. In some implementations, the power saving configuration may comprise lowMobilityEvaluation and cellEdgeEvaluation defined in 3GPP TR 38.304. The configuration of lowMobilityEvaluation may configure the UE to evaluate whether the UE is in a low mobility status (e.g., whether UE's location changes fast). The configuration of cellEdgeEvaluation may configure the UE to evaluate whether UE's position is at a cell edge. When the UE is configured lowMobilityEvaluation or cellEdgeEvaluation, or configured lowMobilityEvaluation and cellEdgeEvaluation, the UE may determine whether to perform relaxed measurements for power saving or not to perform measurements for power saving based on these parameters (i.e., lowMobilityEvaluation or cellEdgeEvaluation). Therefore, in the example, at 120, the UE may perform the measurement based on the configured power saving configuration. Then, the UE or the network node may determine whether at least condition is met according to the measurement result for the power saving configuration. Specifically, when the UE or the network node determines to perform power saving according to the measurement result for the power saving configuration (e.g., the UE is in low mobility or the UE is not at a cell edge), the UE or the network node may determine the condition is met. When the condition is met, it means that the UE can skip the measurements and the downlink scheduling and/or the uplink scheduling between UE and network node may be allowed in the at least one measurement gap.

In another example, the condition may comprise that a channel quality of serving cell is larger than a threshold. Specifically, the UE or the network node may determine whether channel quality of serving cell is larger than the threshold. When the channel quality of serving cell is larger than the threshold (i.e., the channel quality is good), the UE or the network node may determine the condition is met. When the condition is met, it means that the UE can skip the measurements and the downlink scheduling and the uplink scheduling between UE and network node may be allowed in the at least one measurement gap.

It should be noted that the above examples are only some implementations of the present disclosure, but the present disclosure should not be limited thereto. Other conditions also may be served as the condition of the present disclosure. Furthermore, in some implementations, different conditions may be combined to determine.

Referring to FIG. 1, at 130, the UE may transmit a measurement report (e.g., a radio resource management (RRM) report) to the network node to inform that the network node is able to schedule data within the at least one measurement gap. Specifically, when the at least condition is met at 120, the UE may transmit the measurement report to the network node to inform that the network node is able to schedule data within the at least one measurement gap.

At 140, the DL scheduling and the uplink UL scheduling between UE and network node are allowed in the measurement gap. That is, the UE may perform data reception or data transmission within the at least one measurement gap when the at least one condition is met. In some implementations of the present disclosure, the UE or the network node may determine not to perform measurements on non-serving cells, inter-frequency non-serving cells, or inter-band non-serving cells within the at least one measurement gap which is used to schedule data.

FIG. 2 illustrates an example scenario 200 under schemes in accordance with implementations of the present disclosure. Scenario 200 involves a UE and a network node, which may be a part of a wireless communication network (e.g., an LTE network, a 5G/NR network, an IoT network or a 6G network). As shown in FIG. 2, at 210, the network node may transmit a measurement configuration to the UE. The measurement gap configuration may be associated with one or more measurement gap. The measurement gap may be originally configured to the UE for measurement by the network node.

At 220, the network node may determine whether at least condition is met. In some implementations of the present disclosure, the network node may determine whether at least condition is met based on the measurement report (e.g., the measurement report at 130 of FIG. 1) from the UE. In some implementations, the network node may determine whether at least condition is met based on other information (e.g., channel state information (CSI) report) which the network node can collect or obtain from the UE or other sources. The network node may also comprehensively consider all information from the UE to determine whether at least condition is met.

At 230, the network node may transit downlink control information (DCI) or medium access control-control element (MAC-CE) based on the determination at 210. The DCI or MAC-CE may be used to activate or deactivate at least one measurement gap. When the UE receives the DCI or MAC-CE, the UE may know whether the DL scheduling and the uplink UL scheduling between UE and network node are allowed in the at least one measurement gap or not. In some implementations, when the network node configures more than one measurement gap to the UE, the DCI or MAC-CE may indicate a bit map or a pattern to inform the UE of which measurement gaps are used to schedule data.

At 240, when the DCI or MAC-CE indicates that the at least one measurement gap is deactivated, i.e., the DL scheduling and the uplink UL scheduling between UE and network node are allowed in the at least one measurement gap. The network node may perform the DL scheduling and the uplink UL scheduling with the UE in the at least one measurement gap.

### Illustrative Implementations

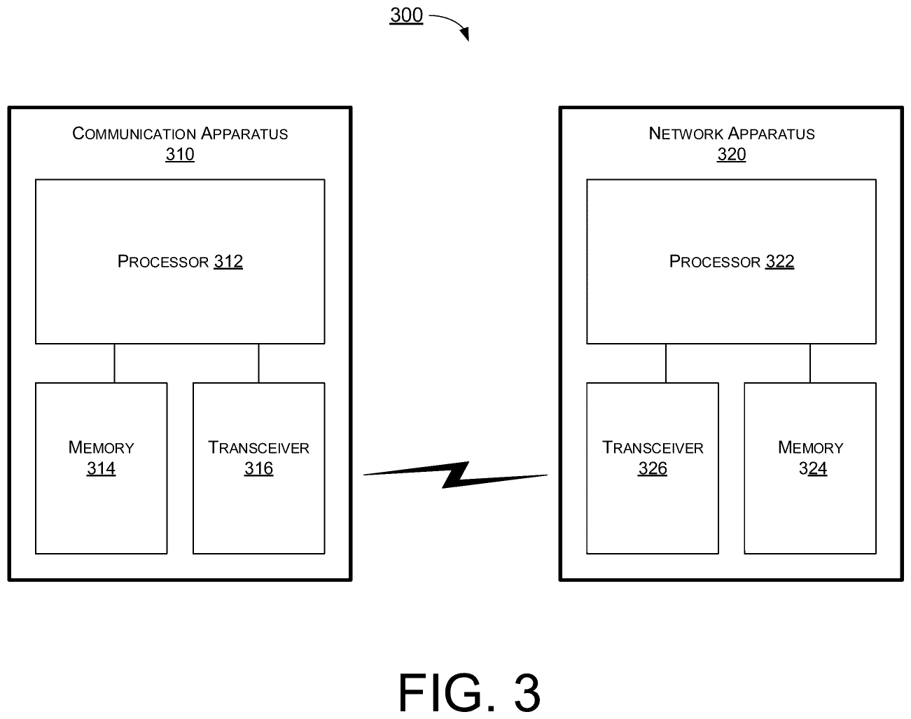

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to data scheduling within measurement gaps with respect to user equipment and network apparatus in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIOT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may receive, via transceiver 316, a measurement gap configuration associated with at least one measurement gap from network apparatus 320. Processor 312 may determine whether at least one condition is met. Processor 312 may perform, via transceiver 316, data reception or data transmission within the at least one measurement gap in an event that the at least one condition is met. In some implementations, processor 322 may determine whether at least one condition is met. Processor 322 may determine whether the DL scheduling and/or UL scheduling are allowed according to the at least condition. Processor 322 may also indicate communication apparatus 310 in an event that the at least condition is met. Then communication apparatus 310 may be allowed to perform data reception or data transmission within the at least one measurement gap.

In some implementations, processor 312 may transmit, via transceiver 316, a measurement report to network apparatus 320 to inform that network apparatus 320 is able to schedule data within the at least one measurement gap.

In some implementations, processor 312 may receive, via transceiver 316, at least one power saving configuration from network apparatus 320. Processor 312 or processor 322 may determine whether the at least one condition is met according to the at least one power saving configuration. In some implementations, the at least one power saving configuration comprises lowMobilityEvaluation and cellEdgeEvaluation.

In some implementations, the at least one condition may comprise that processor 312 or processor 322 determines that a channel quality is larger than a threshold.

In some implementations, processor 312 or processor 322 may determine not to perform measurements on non-serving cells, inter-frequency non-serving cells, or inter-band non-serving cells within the at least one measurement gap which is used to schedule data.

In some implementations, processor 312 may receive, via transceiver 316, a DCI or MAC-CE for activating or deactivating the at least one measurement gap from network apparatus 320. Processor 312 may determine whether to perform data reception or data transmission within the at least one measurement gap based on the DCI or MAC-CE. In some implementations, the DCI or MAC-CE indicates a bit map or a pattern for the at least one measurement gap which is used to schedule data.

In some implementations, processor 322 may transmit, via transceiver 326, a measurement gap configuration associated with at least one measurement gap to communication apparatus 310. Processor 322 may determine whether at least one condition is met. Processor 322 may determine whether to schedule data within the at least one measurement gap according to the at least one condition.

In some implementations, processor 322 may receive, via transceiver 326, a measurement report or other information from communication apparatus 310. Processor 322 may determine whether the at least one condition is met according to the measurement report or the other information. Processor 322 may schedule data within the at least one measurement gap in an event that the at least one condition is met.

In some implementations, processor 322 may determine a DCI or MAC-CE for activating or deactivating the at least one measurement gap according to the at least one condition. Processor 322 may transmit, via transceiver 326, the DCI or MAC-CE to communication apparatus 310. In some implementations, the DCI or MAC-CE may indicate a bit map or a pattern for the at least one measurement gap which is used to schedule data.

### Illustrative Processes

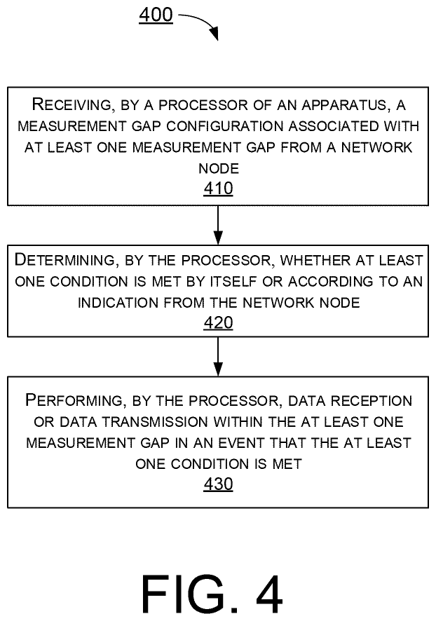

FIG. 4 illustrates an example process 400 in accordance with an implementation of the present disclosure. Process 400 may be an example implementation of above scenarios/schemes, whether partially or completely, with respect to data scheduling within measurement gaps with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a measurement gap configuration associated with at least one measurement gap from a network node. Process 400 may proceed from 410 to 420.

At 420, process 400 may involve processor 312 determining whether at least one condition is met by itself or according to an indication from the network node. Process 400 may proceed from 420 to 430.

At 430, process 400 may involve processor 312 performing data reception or data transmission within the at least one measurement gap in an event that the at least one condition is met.

In some implementations, process 400 may further involve processor 312 transmitting a measurement report to the network node to inform that the network node is able to schedule data within the at least one measurement gap.

In some implementations, process 400 may further involve processor 312 receiving at least one power saving configuration from the network node, and determining whether the at least one condition is met according to the at least one power saving configuration.

In some implementations, process 400 may further involve processor 312 determining that a channel quality is larger than a threshold.

In some implementations, process 400 may further involve processor 312 determining not to perform measurements on non-serving cells, inter-frequency non-serving cells, or inter-band non-serving cells within the at least one measurement gap which is used to schedule data.

In some implementations, process 400 may further involve processor 312 receiving a DCI or MAC-CE for activating or deactivating the at least one measurement gap from the network node, and determining whether to perform data reception or data transmission within the at least one measurement gap based on the DCI or MAC-CE.

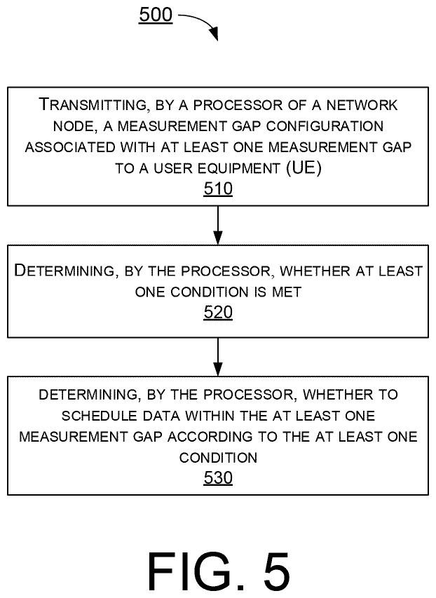

FIG. 5 illustrates an example process 500 in accordance with an implementation of the present disclosure. Process 500 may be an example implementation of above scenarios/schemes, whether partially or completely, with respect to data scheduling within measurement gaps with the present disclosure. Process 500 may represent an aspect of implementation of features of network apparatus 320. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any base stations or network nodes. Solely for illustrative purposes and without limitation, process 500 is described below in the context of network apparatus 320. Process 500 may begin at block 510.

At 510, process 500 may involve processor 322 of network apparatus 320 transmitting a measurement gap configuration associated with at least one measurement gap to a user equipment (UE). Process 500 may proceed from 510 to 520.

At 520, process 500 may involve processor 322 determining whether at least one condition is met. Process 500 may proceed from 520 to 530.

At 530, process 500 may involve processor 322 determining whether to schedule data within the at least one measurement gap according to the at least one condition.

In some implementations, process 500 may further involve processor 322 receiving a measurement report or other information from the UE, determining whether the at least one condition is met according to the measurement report or the other information, and scheduling data within the at least one measurement gap in an event that the at least one condition is met.

In some implementations, process 500 may further involve processor 322 determining a DCI or MAC-CE for activating or deactivating the at least one measurement gap according to the at least one condition, and transmitting the DCI or MAC-CE to the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a measurement gap configuration associated with at least one measurement gap from a network node;
determining, by the processor, whether at least one condition is met; and
performing, by the processor, data reception or data transmission within the at least one measurement gap in an event that the at least one condition is met.

2. The method of claim 1, further comprising:
transmitting, by the processor, a measurement report to the network node to inform that the network node is able to schedule data within the at least one measurement gap.

3. The method of claim 1, wherein the at least one condition comprises:
receiving, by the processor, at least one power saving configuration from the network node; and
determining, by the processor, whether the at least one condition is met according to the at least one power saving configuration.

4. The method of claim 3, wherein the at least one power saving configuration comprises lowMobilityEvaluation and cellEdgeEvaluation.

5. The method of claim 1, wherein the at least one condition comprises:
determining, by the processor, that a channel quality is larger than a threshold.

6. The method of claim 1, further comprising:
determining, by the processor, not to perform measurements on non-serving cells, inter-frequency non-serving cells, or inter-band non-serving cells within the at least one measurement gap which is used to schedule data.

7. The method of claim 1, further comprising:
receiving, by the processor, a downlink control information (DCI) or medium access control-control element (MAC-CE) for activating or deactivating the at least one measurement gap from the network node; and
determining, by the processor, whether to perform data reception or data transmission within the at least one measurement gap based on the DCI or MAC-CE.

8. The method of claim 7, wherein the DCI or MAC-CE indicates a bit map or a pattern for the at least one measurement gap which is used to schedule data.

9. An apparatus, comprising:
a transceiver which, during operation, wirelessly communicates with a network node; and
a processor communicatively coupled to the transceiver such that, during operation, the processor performs operations comprising:
receiving, via the transceiver, a measurement gap configuration associated with at least one measurement gap from a network node;
determining whether at least one condition is met; and
performing, via the transceiver, data reception or data transmission within the at least one measurement gap in an event that the at least one condition is met.

10. The apparatus of claim 9, wherein, during operation, the processor further performs operations comprising:
transmitting, via the transceiver, a measurement report to the network node to inform that the network node is able to schedule data within the at least one measurement gap.

11. The apparatus of claim 9, wherein, during operation, the processor further performs operations comprising:
receiving, via the transceiver, at least one power saving configuration from the network node; and
determining whether the at least one condition is met according to the at least one power saving configuration.

12. The apparatus of claim 11, wherein the at least one power saving configuration comprises lowMobilityEvaluation and cellEdgeEvaluation.

13. The apparatus of claim 9, wherein the at least one condition comprises determining that a channel quality is larger than a threshold.

14. The apparatus of claim 9, wherein, during operation, the processor further performs operations comprising:
determining not to perform measurements on non-serving cells, inter-frequency non-serving cells, or inter-band non-serving cells within the at least one measurement gap which is used to schedule data.

15. The apparatus of claim 9, wherein, during operation, the processor further performs operations comprising:
receiving, via the transceiver, a downlink control information (DCI) or medium access control-control element (MAC-CE) for activating or deactivating the at least one measurement gap from the network node; and
determining whether to perform data reception or data transmission within the at least one measurement gap based on the DCI or MAC-CE.

16. The apparatus of claim 15, wherein the DCI or MAC-CE indicates a bit map or a pattern for the at least one measurement gap which is used to schedule data.

17. A method, comprising:
transmitting, by a processor of a network node, a measurement gap configuration associated with at least one measurement gap to a user equipment (UE);
determining, by the processor, whether at least one condition is met; and
determining, by the processor, whether to schedule data within the at least one measurement gap according to the at least one condition.

18. The method of claim 17, further comprising:
receiving, by the processor, a measurement report or other information from the UE;
determining, by the processor, whether the at least one condition is met according to the measurement report or the other information; and
scheduling, by the processor, data within the at least one measurement gap in an event that the at least one condition is met.

19. The method of claim 17, further comprising:
determining, by the processor, a downlink control information (DCI) or medium access control-control element (MAC-CE) for activating or deactivating the at least one measurement gap according to the at least one condition; and
transmitting, by the processor, the DCI or MAC-CE to the UE.

20. The method of claim 17, wherein the DCI or MAC-CE indicates a bit map or a pattern for the at least one measurement gap which is used to schedule data.
